(19) United States
(12) Patent Application Publication
(10) Pub. No.: US 2024/0126972 A1
(43) Pub. Date: Apr. 18, 2024

(54) Method and Apparatus for Programmatic Wireless Charging

(71) Applicant: Northeastern University, Boston, MA (US)

(72) Inventors: Yousof NADERI, Brookline, MA (US); Kaushik CHOWDHURY, Needham, MA (US)

(21) Appl. No.: 18/277,402

(22) PCT Filed: Mar. 9, 2022
(86) PCT No.: PCT/US22/19638

§ 371 Date: Aug. 16, 2023

Related U.S. Application Data
(60) Provisional application No. 63/158,395, filed on Mar. 9, 2021.

(51) Int. Cl. G06F 30/392; G06F 30/12; H02J 7/00; H02J 50/00; H02J 50/10; H02J 50/40; H02J 50/80; H02J 50/90

(52) U.S. Cl. CPC G06F 30/392; G06F 30/12; H02J 7/00034; H02J 7/00047; H02J 7/0013; H02J 50/005; H02J 50/10; H02J 50/402; H02J 50/80; H02J 50/90; G06F 2115/12

(57) ABSTRACT

Programmatic development of a software-defined wireless charging apparatus capable of charging multiple and different devices simultaneously is presented. Developer software is used to input specifications for the charging apparatus and generate configuration files that are used to configure operating software for the charging apparatus. The developer software can also design configurable hardware for fabrication of the charging apparatus, and can provide diagnostic data for use in optimizing the charging apparatus design. Wireless charging systems having novel capabilities are also provided.

### CROSS-REFERENCE TO RELATED APPLICATIONS

This application claims priority to U.S. Provisional Appl. No. 63/158,395, filed 9 Mar. 2021 and entitled “Method and Apparatus for Programmatic Wireless Charging”, which is incorporated by reference herein in its entirety.

### STATEMENT REGARDING FEDERALLY SPONSORED RESEARCH OR DEVELOPMENT

This invention was made with government support under Grant Number 1452628 awarded by NSF National Science Foundation. The government has certain rights in the invention.

### BACKGROUND

Current state of the art wireless charging solutions present challenges for developers and consumers. The common process for companies to develop a customized high-performance wireless charging solution is to reach out to a wireless charging design firm that can develop a particular solution for their needs. However, customized charging solution development is expensive and lengthy due to the cost of engineering efforts and manual development. This requires extensive engineering resources, multiple diverse expertise, and a need for new hardware and software developments. The wireless charging industry and solution developers have mostly focused on single transmitter and single receiver solutions with hardware having very limited reconfigurability or intelligent capabilities. Moreover, different standard organizations have been developing independent versions of wireless charging standards and new specifications that change frequently and create compatibility issues. The existing development process creates risks of non-compatibility with standards and lack of interoperability, along with delayed time to market. The different ecosystems involved block the speed of innovation, limit the scale and capacity of charging, result in small and frequent hardware modifications and improvements, and do not address the real and diverse needs of users.

Further, there has been exponential growth in the number of wireless charging transmitters and integration of receivers in all segments of the wireless charging market, including mobile devices from all major consumer electronics companies. This growth has created massive demand for wireless charging infrastructure in recent years and significantly increased customer demands and expectation for the use of wireless charging. Growth of this industry also has changed the perception and mindset of customers toward wireless charging from non-practical to a must-have feature. and also has increased the wireless charging market size and number of applications. The demand for efficient charging infrastructure has increased significantly across the consumer electronics domain. Additionally, there is a need for charging infrastructure that is easier to use, can transfer power safely to devices, and puts minimal strain on a charging port.

Major standard organizations such as the Wireless Power Consortium (WPC) and AirFuel have further improved their standards (for one transmitter and one receiver) and are developing specifications for medium and high-power ranges. While these improvements have not provided expected convenience for users, they have created a growth expectation in the market for more intelligent and better performance solutions—for “wireless charging 2.0”.

Convenience has become the number one market deriver in the wireless charging market, and this makes it essential to find higher performance, more convenient surface wireless charging solutions. Nearly every member of the general public has multiple chargeable devices, such as smartphones, laptops, touchpads, and even power tools, each with its own charger. Thus, there will soon be significant demand for multi-device charging solutions.

The shortcomings in the current process of customized wireless charging solution development along with the increasing expectation of the wireless charging market to use, adapt, and integrate quickly the next generation of high-performance and more convenient solutions all necessitate a better way, which does not exist today, for the development of customized high-performance solutions.

### SUMMARY

A programmatic wireless charging system development platform is provided which overcomes the shortcomings of existing wireless charging systems and their development. The platform includes software, firmware, and a development process that enable developers to programmatically build and deploy high-performance wireless charging systems. Instead of building hardware and software that has been designed for a specific protocol or standard with pre-determined and pre-programmed configurations, the platform described herein enables a developer to configure, re-configure, and optimize programmatically the parameters of a wireless charging system via an easy-to-use interface before, during, and after the development as well as over the operation of the system. The integration of the platform allows for software to work seamlessly with reconfigurable charging hardware using configuration files and policies. This empowers wireless charging development processes and systems with higher flexibility, charging capacity, efficiency, and safety.

The technology also can be summarized in the following list of features.
1. A system for programmatically designing a software-defined wireless charging apparatus, the system comprising a processor configured to:
   (i) receive an input of specifications from a user for the wireless charging apparatus using developer software;
   (ii) generate one or more configuration files for the wireless charging apparatus based on the specifications using the developer software; and
   (iii) configure operating software for the wireless charging apparatus using the developer software in accordance with the configuration files;
   wherein the wireless charging apparatus is designed for simultaneously charging one or more chargeable devices.
2. The system of feature 1, wherein the specifications are input by the user through a configuration menu of the developer software.
3. The system of feature 1 or feature 2, wherein the specifications are selected from the group consisting of types of device to be charged, number of devices to be charged simultaneously, charging area size, output power requirements, charging standard to be used, hardware configuration of the wireless charging apparatus and combinations thereof.
4. The system of any of the preceding features, wherein the operating software is configured in (iii) with respect to its ability to sense the presence, size, position, and/or identity of chargeable devices disposed on a charging surface of the wireless charging apparatus; shape an energy field over the charging surface based on size, position, and/or identity of detected devices on the charging surface; allocate power to a plurality of devices and/or of different types of devices on the charging surface; activate and set operational characteristics of one or more charging coils disposed beneath the charging surface; execute one or more charging policies for devices on the charging surface; share information among energy hubs of the system; and/or collect and share information related to charging of chargeable devices on the charging surface.
5. The system of any of the preceding features, further comprising:
   (iv) generating a configurable hardware design and/or listing of hardware components for the wireless charging apparatus using the one or more configuration files and the developer software.
6. The system of feature 5, wherein the configurable hardware design comprises a layout of configurable charging coils disposed on one or more printed circuit boards.
7. The system of feature 5 or feature 6, wherein the configurable hardware design comprises a configurable power supply disposed on a printed circuit board.
8. The system of any of features 5-7, wherein the hardware design comprises a configurable charging coil array.
9. The system of any of features 5-8, wherein the hardware design comprises a firmware stack.
10. The system of any of features 5-9, wherein the configurable hardware design comprises a plurality of charging hubs for attachment to a lower side of a surface to create a charging surface, wherein the plurality of charging hubs are configured to transmit energy amongst one another by induction, and wherein each of the plurality of charging hubs is configured to transmit energy through the surface to charge one or more devices disposed on an upper side of the surface.
11. The system of feature 10, wherein the plurality of charging hubs comprises a master hub and one or more slave hubs, and wherein the master hub is connected to a power source and transmits energy to the one or more slave hubs.
12. The system of feature 10 or feature 11, wherein the surface is selected from the group consisting of furniture surfaces, tables, desks, restaurant and coffeeshop tables, countertops, bar tops, and surfaces of motor vehicles, planes, and trains.
13. The system of any of the preceding features, further comprising one or more pre-defined configurable hardware designs available for selection by the developer software in accordance with the configuration files.
14. The system of any of the preceding features, wherein the one or more chargeable devices include at least two different types of chargeable devices.
15. The system of any of the preceding features, wherein the one or more chargeable devices are selected from the group consisting of smartphones, smartwatches, wireless headphones, laptops, computer displays, touchpads, pointing devices, wireless speakers, smart home devices, remote controls, cameras, televisions, radios, medical devices, power tools, drones, robots, and electric vehicles.
16. The system of any of the preceding features, wherein the operating software is configured with respect to its ability to receive and/or display performance data from the wireless charging apparatus.
17. The system of feature 16, wherein the performance data comprise power transmission data, power receipt data from a chargeable device, charging efficiency, projected battery life, and/or temperature data.
18. A software-defined wireless charging apparatus designed by the system of any of the preceding features, wherein the wireless charging apparatus comprises:
   an array of charging coils;
   a power module; and
   a processor configured to sense and identify one or more chargeable devices placed in proximity to the charging coils and operate the charging coils and power module so as to charge said one or more chargeable devices;
   wherein the wireless charging apparatus is operational to simultaneously charge one or more chargeable devices.
19. The software-defined wireless charging apparatus of feature 18, wherein the apparatus is operational to simultaneously charge different types and/or numbers of chargeable devices and/or to charge devices having different power requirements.
20. The software-defined wireless charging apparatus of feature 18 or feature 19, further comprising one or more of an internet node, a 4G network node, a 5G network node, and an edge computing network node.
21. The software-defined wireless charging apparatus of any of features 18-20, wherein the apparatus is configured as a plurality of charging hubs for attachment to a lower side of a surface to create a charging surface, wherein the plurality of charging hubs are configured to transmit energy amongst one another by induction, and wherein each of the plurality of charging hubs is configured to transmit energy through the surface to charge one or more devices disposed on an upper side of the surface.
22. The software-defined wireless charging apparatus of any of features 18-21, wherein the one or more chargeable devices are selected from the group consisting of smartphones, smartwatches, wireless headphones, laptops, computer displays, touchpads, pointing devices, wireless speakers, smart home devices, remote controls, cameras, televisions, radios, medical devices, power tools, drones, robots, and electric vehicles.
23. The software-defined wireless charging apparatus of any of features 18-22, wherein the device is configured as a laptop work surface, a laptop case, a computer monitor, tablet, or television stand, a desk top, a counter top, a table top, an article of furniture, an airplane drop-down table, a robot charging device, an unmanned aerial vehicle charging device, an automotive vehicle charging device, a power tool charging device, or a multipurpose device charging surface.
24. The software-defined wireless charging apparatus of any of features 18-23, wherein the processor is further configured to collect data related to device charging characteristics, battery status, power usage by device, coil configuration, or temperature of the apparatus, and optionally transmit the data to a mobile phone app.
25. A method of designing a software-defined wireless charging apparatus comprising the steps of:
   (a) inputting specifications of the wireless charging apparatus into wireless charging apparatus developer software;
   (b) generating one or more configuration files for the wireless charging apparatus based on the specifications using the developer software; and
   (c) configuring operating software for the wireless charging apparatus using the developer software based on the one or more configuration files;
   wherein the wireless charging apparatus is designed for simultaneously charging one or more chargeable devices.
26. The method of feature 25, further comprising:
   (d) generating a configurable hardware design and/or listing of hardware components for the wireless charging apparatus using the one or more configuration files and the developer software.
27. The method of feature 25, wherein the configurable hardware design comprises a layout of configurable charging coils disposed on one or more printed circuit boards.
28. The method of feature 26 or feature 27, wherein the configurable hardware design comprises a configurable power supply disposed on a printed circuit board.
29. The method of any of features 26-28, wherein the configurable hardware design comprises a configurable charging coil array.
30. The method of any of features 26-29, wherein the configurable hardware design comprises a firmware stack.
31. The method of any of features 25-30, wherein the specifications are input by the user through a configuration menu.
32. The method of any of features 25-31, wherein the specifications are selected from the group consisting of types of device to be charged, number of devices to be charged simultaneously, charging area size, output power requirements, charging standard to be used, hardware configuration of the wireless charging apparatus, and combinations thereof.
33. The method of any of features 25-32, wherein the operating software is configured in (c) with respect to its ability to sense the presence, size, position, and/or identity of chargeable devices disposed on a charging surface of the wireless charging apparatus; shape an energy field over the charging surface based on size, position, and/or identity of detected devices on the charging surface; allocate power to a plurality of devices and/or of different types of devices on the charging surface; activate and set operational characteristics of one or more charging coils disposed beneath the charging surface; execute one or more charging policies for devices on the charging surface; share information among energy hubs of the system; and/or collect and share information related to charging of chargeable devices on the charging surface.
34. The method of any of features 25-33, wherein the configurable hardware design comprises a plurality of charging hubs for attachment to a lower side of a surface to create a charging surface, wherein the plurality of charging hubs are configured to transmit energy amongst one another by induction, and wherein each of the plurality of charging hubs is configured to transmit energy through the surface to charge one or more devices disposed on an upper side of the surface.
35. The method of feature 34, wherein the plurality of charging hubs comprises a master hub and one or more slave hubs, and wherein the master hub is connected to a power source and transmits energy to the one or more slave hubs.
36. The method of feature 34 or feature 35, wherein the surface is selected from the group consisting of furniture surfaces, tables, desks, restaurant and coffeeshop tables, countertops, bar tops, and surfaces of motor vehicles, planes, and trains.
37. The method of any of features 26-36, wherein the configurable hardware design configured by the developer software is selected from one or more pre-defined configurable hardware designs available for selection by the developer software in accordance with the configuration files.
38. The method of any of features 25-37, wherein the one or more chargeable devices include at least two different types of chargeable devices.
39. The method of any of features 25-38, wherein the one or more chargeable devices are selected from the group consisting of smartphones, smartwatches, wireless headphones, laptops, computer displays, touchpads, pointing devices, wireless speakers, smart home devices, remote controls, cameras, televisions, radios, medical devices, power tools, drones, robots, and electric vehicles.
40. The method of any of features 25-39, wherein the operating system is operative to collect performance data from the wireless charging apparatus and displaying the performance data and/or representations thereof for evaluation by a user.
41. The method of feature 40, further comprising:
   (e) collecting said performance data;
   (f) using the developer software to generate one or more revised configuration files for the wireless charging apparatus; and
   (g) reconfiguring the operating software using the developer software in accordance with the revised configuration files.
42. The method of feature 41, wherein steps (e) through (g) are repeated one or more times.
43. The method of any of features 40-42, wherein the performance data comprise power transmission data, power receipt data from a chargeable device, charging efficiency, projected battery life, and/or temperature data.
44. A system for wireless charging, the system comprising:
   (i) the software-defined wireless charging apparatus of any of features 18-24; and
   (ii) a power receiver for receiving energy from the wireless charging apparatus.
45. The system of feature 44, wherein the power receiver is integrated within a chargeable device.
46. The system of feature 45, wherein the power receiver is integrated within a batter of the chargeable device.
47. The system of feature 44, wherein the power receiver is disposed in a separate device.
48. The system of feature 47, wherein the separate device is selected from a power dongle that attaches to a chargeable device, a case for a chargeable device, and a stand for a chargeable device.
49. The system of any of features 44-48, wherein the power receiver is operative to send feedback data to the wireless charging apparatus.

### BRIEF DESCRIPTION OF THE DRAWINGS

FIG. 1A is a flow chart of a process for developing a wireless charging system, as part of a wireless charging system development platform. FIG. 1B is a screen shot of a configuration menu from software for a wireless charging system development platform.

FIG. 2 shows a firmware stack for a wireless charging system development platform.

FIG. 3A shows the form of three different induction coils for use in a wireless charging device transmitter. FIG. 3B shows three different layouts of induction coil arrays for use in a wireless charging device transmitter.

FIG. 4A shows a schematic illustration of printed circuit boards of a master tile of a transmitter tile array for a wireless charging surface. FIG. 4B shows a schematic illustration of printed circuit boards of a slave tile of a transmitter tile array for a wireless charging surface.

FIG. 5A shows an embodiment of a main circuit board and a circuit board containing a coil array for device sensing and wireless charging. FIG. 5B shows the mounting of circuit boards in a housing for a wireless charging surface device. FIG. 5C shows circuit boards for another embodiment of a power module and coil array. FIG. 5D shows mounting of the circuit boards of FIG. 5C in a housing for a tile for a wireless charging surface.

FIG. 6A (top left) shows three wireless devices being charged on a wireless charging surface containing an array of coils for device sensing and wireless charging. FIG. 6B (top right) shows a laptop workstation charging surface containing a coil array for wireless charging of the laptop and other devices. FIG. 6C (bottom) shows a display from software for monitoring a wireless charging process using a wireless charging system development platform, depicting automated device detection by a charging surface.

FIG. 7 shows a display from software for monitoring a wireless charging system. The display indicates the status of tiles of a multi-tile charging array of a charging surface as well as history of device detection for a selected tile.

FIGS. 8A-8I show a variety of applications of wireless charging systems made using a wireless charging system development platform of the present technology.

### DETAILED DESCRIPTION

The present technology provides a programmatic development platform useful for designing a wide variety of wireless charging systems, including surfaces for intelligent detection and simultaneous charging of a plurality of different devices. The technology addresses the shortcomings of existing wireless charging development methods and provides an easy to use programmatic development process.

The terms “wireless charging system development process” and wireless charging system development platform” are used synonymously herein. The platform enable developers to programmatically build and deploy high-performance wireless charging systems. Each such system includes one or more transmitters or charging surfaces as well as the firmware and software required for its operation. Instead of building hardware and software that has been custom designed for a specific protocol, standard, or chargeable device with pre-determined and pre-programmed configurations, the platform enables a developer to configure, test, reconfigure, and optimize programmatically the desired features, requirements, and system parameters via an easy-to-use software interface. The integrated hardware and software system allows for software to work seamlessly with the reconfigurable charging hardware using the configuration files and policies. This empowers the developer or end user with greater flexibility, charging capacity, efficiency, and safety. Further, the present technology platform provides an end-to-end turnkey approach to developing wireless charging systems that saves time and costs compared to traditional methods.

A system for programmatically designing a software-defined wireless charging apparatus includes a processor configured to: (i) receive an input of specifications from a user for the wireless charging apparatus using developer software; (ii) generate one or more configuration files for the wireless charging apparatus based on the specifications using the developer software; and (iii) configure operating software for the wireless charging apparatus using the developer software in accordance with the configuration files. The wireless charging apparatus is designed for simultaneously charging one or more chargeable devices.

The developer software serves to collect profile or configuration information from the developer and uses that profile or information to configure the operating system of the wireless charging apparatus. The developer software can be a software developer kit which includes a user interface that interrogates the designer to input required specifications to operate the charging apparatus. The specifications can be, for example, features or identities of chargeable devices for use with the charging apparatus, parameters for operating the charging coils (e.g., frequency, power, and which coils of an array to activate), industry wireless charging standards for use with the apparatus, power output levels that the apparatus should achieve, number of individual charging pods to be used in the apparatus, types of data to be collected by the apparatus during use. The developer software then creates one or more configuration files, which can be used to modify the action of the operating software which controls the operation of the wireless charging apparatus in use. The developer software also can be used to design hardware for the charging apparatus, and to collect data useful in diagnosing and improving the performance of the charging apparatus.

The operating software can configure and control aspects of the apparatus including a power module of the apparatus, the charging coils of the apparatus, the methods including artificial intelligence used to sense the presence of chargeable devices placed in proximity to the coils (e.g., onto a charging surface of the apparatus), the ability of the coils to shape a magnetic field created by the coils and used to charge selected devices, adjustment of charging conditions in response to information about a device or battery condition, data collection by the apparatus, data transmission by the apparatus to one or more remote devices such as mobile phones, connection of the apparatus to a router, a network, the Internet, or a 4G, 5G, or other mobile phone or data network, or to a payment network, and coordination, power sharing, and communication among one or more individual charging pods of the apparatus. The operating software is preferably organized as a series of stacks. The operating software is configurable by the designer software. The hardware of the charging apparatus can be configured by the operating software during operation of the apparatus. For example, the impedance of the charging coils and/or sensing coils of the apparatus are configurable by the operating software. Other hardware components, such as those providing current and voltage output levels or limits, can be configured by the operating software during operation of the charging apparatus in response to charging requirements and to ensure safe operation.

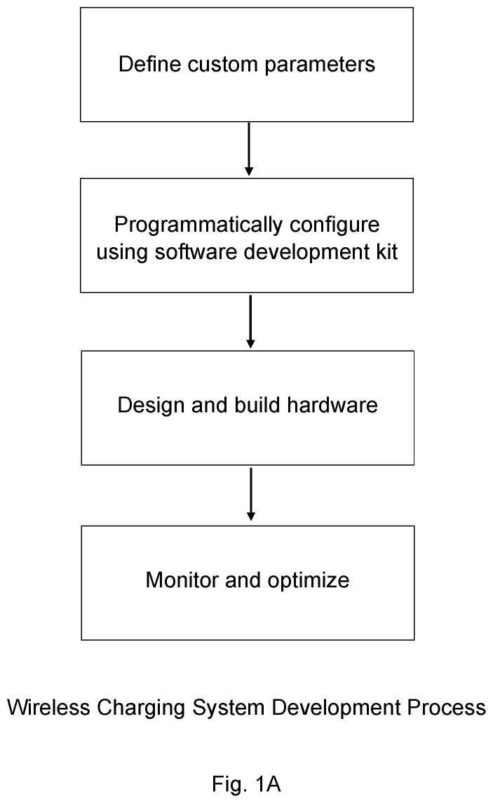

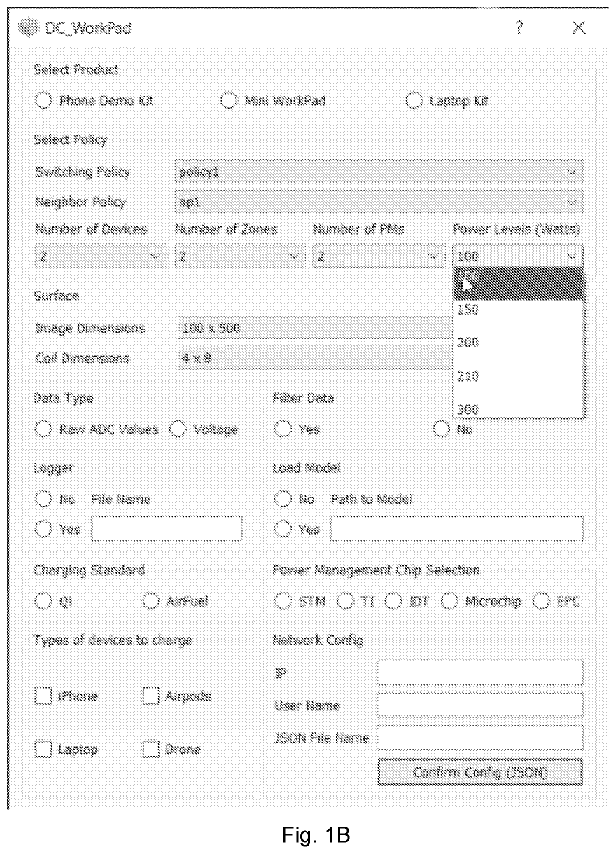

FIG. 1 depicts the four main aspects of the platform that work together to enable the programmable development of a wireless charging system. The first step is to define or collect the custom parameters for the system. The second step is to enter the parameters into a user interface of the platform software, and to allow the software to design and/or configure the necessary hardware to operate the wireless charging system. The third step is to physically design, build, or select the appropriate hardware. The fourth step is to test, monitor, and optimize the wireless charging system (both hardware and software), with assistance of the platform software.

### Customization

Wireless charging takes place typically by electromagnetic induction, whereby oscillations in a magnetic field in a closed conduction loop create similar oscillations in a separate closed loop situated within a suitable distance. There are different variations used for wireless charging, including (i) tightly coupled (non-radiative) electromagnetic induction, (ii) loosely coupled (radiative) electromagnetic resonant induction, and (iii) uncoupled radio frequency (RF) charging. These have different applicability, such as different power transfer capability and functionality over different transmission distances. In addition, major standards organizations such as the Wireless Power Consortium (WPC, developer of the Qi standard), the Power Matters Alliance (PMA, developer of the Powermat standard), and the Alliance for Wireless Power (A4WP, developer of the AirFuel standard) have set specifications used by various industries and manufacturers. The standards differ, for example, in the frequency used in the charging coils, and in other characteristics that determine the wireless charger hardware required for a given wireless charging system.

A developer seeking to design a wireless charging system for a certain device or collection of devices will need to configure the charging device hardware for compatibility with the standards used for the device(s), and the standards may change over time. The development platform of the present technology allows the developer to input the required specifications, such as size of the charging area, the amount of power needed, the types of devices that the pad charges, the number of devices that can be charged at once, charging coil frequency, number and distribution of coils, current level as a function of time, and device detection parameters, and the like. A developer or manufacturer can develop multiple products by simply changing product development variables. One wireless charging system can now fit essentially all wireless charging product development needs. This eliminates the need developers and their customers to license multiple development technologies.

Preferred is the use of software for the development platform that displays a user interface such as that shown in FIG. 1B, which requests input of the required parameters. Particularly preferred is the coupling of the development software with one or more ready-made and configurable hardware devices that may be selected and/or configured by the developer through use of the development software and its user interface. The user interface thus contemplates both the features required to satisfy the required standard and the needs of the device(s) to be charged as well as the available hardware and its configuration options and presents all required choices to the user for full compliance, operability, and efficiency. The product of the customization process can be, for example, one or more configuration files containing the information required for designing and configuring the hardware.

The customization phase flips the conventional development paradigm. Instead of allowing the technological capabilities of a chargeable device to determine the specifications of its wireless charging system, the developer or manufacturer first lays out the exact specifications they desire in the charging system, such as the size of the charging area, what types of devices they want to be able to charge, the power levels they need, how many devices they want to be able to charge at once, as well as what charging standard they want to adapt. The development software then provides a configuration of the system automatically.

### Programmatic Configuration

The design and configuration stage of the development process can involve a separate software module which inputs the configuration files and automatically and programmatically outputs a hardware design and/or configuration. The present inventors have developed CoilOS software, which inputs data from the configuration files and uses the data to control reconfigurable wireless charging hardware. Preferably, the reconfigurable wireless charging hardware is pre-designed for operability with the software. For example, the configuration software can select a particular hardware “kit” from a number of available options as the best suited for the developer's application, and moreover can configure the hardware kit and operate the hardware as well as monitor the hardware's performance. Alternatively, the configuration software can output the required hardware specifications for use by the developer or manufacturer to construct their own hardware.

### Hardware Construction

The wireless charging hardware to be constructed can include components such as a power supply module, one or more charging coils arranged in a physical array according to requirements of the application, electrical components to regulate the behavior of the coils, and firmware that contains the software governing operation and monitoring of the hardware. The hardware, including the coils, can be incorporated into one or more printed circuit boards (PCBs) that are arranged within a housing adapted to requirements of the end user and devices to be charged. Hardware construction can include selection of an OEM software-defined hardware board which uses power management chips that are compatible with a state-of-the-art standard, such as Qi or AirFuel.

A key hardware component is the firmware that contains and implements the operating and monitoring software. The firmware houses the code that enables the charging coils for various functionalities, including sensing of chargeable devices nearby, as opposed to relying on coil alignment for charging. The firmware's code shapes the energy fields over the charging surface based on the location of detected devices, and thereby optimally allocates and delivers power to a number of different types of devices on the surface simultaneously. The code can create a networked coil architecture, as well as define, configure, and execute different charging policies, and share information among coils and/or energy hubs.

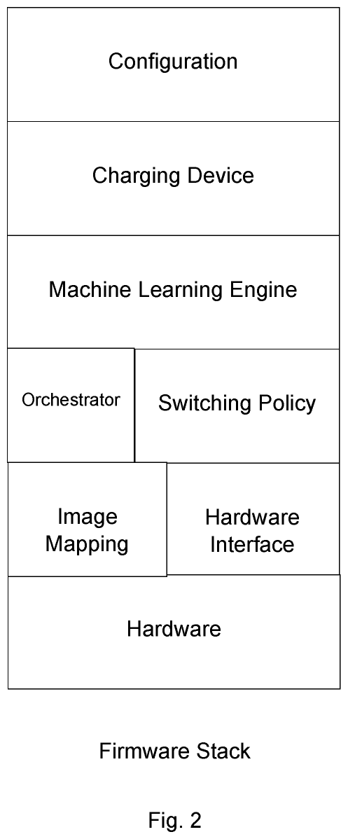

An example of the functional modules of such firmware is shown as the firmware stack of FIG. 2. The configuration layer runs the configuration software and contains the configuration files. The charging device layer runs software specific to the selected hardware kit (e.g., power unit and coils) and its configuration using the configuration files. The machine learning engine runs software responsible for signal sampling, processing, filtering, and application of models for device detection and charging using artificial intelligence. The orchestrator module is responsible for operating the charging device according to charging and switching policies of the detected devices on the charging surface. The switching policy module stores switching policies accessed by the orchestrator. The image mapping module automatically maps charging coils to the chargeable device images. The hardware interface can be, for example, a Raspberry Pi minicomputer or an Arduino microcontroller board that controls the hardware PCB as instructed by the operating software. The hardware layer includes the power supply and coils, together with additional electronics for controlling the frequency and power level, for example, and can be implemented on one or more PCBs or as two or more physical units or “tiles”, each containing one or more PCBs, that operate together to provide a charging surface.

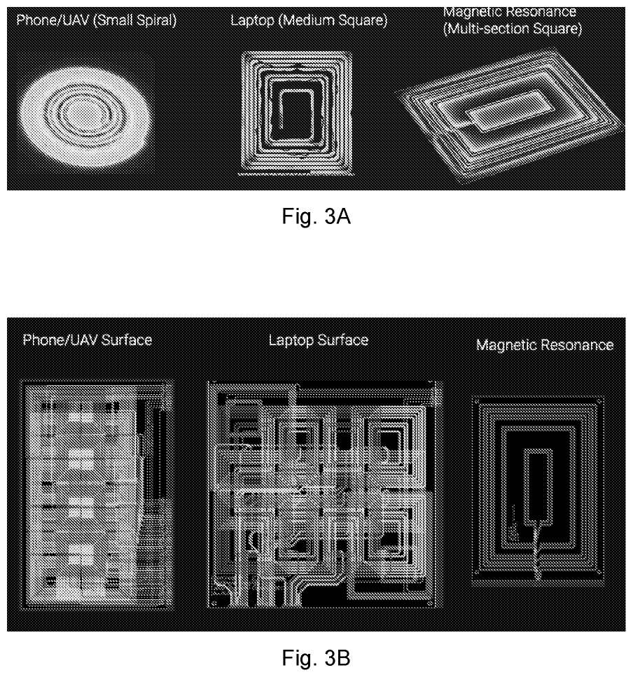

Examples of charging coil physical configurations are shown in FIG. 3A. The charging coil geometry is governed by the geometry and placement of the receiver coil in the chargeable device as well as the power level required and the type of wireless charging mechanism used (i.e., tightly coupled, loosely coupled, or uncoupled). Several charging coils (e.g., 2, 3, 4, 5, 6, 7, 8, 9, 10, or more) can be combined onto one or more coil PCBs in a layout determined by the projected arrangement of one or more chargeable devices on the charging surface. The charging surface is preferably disposed a short distance above the coil PCB(s), as required for the coupling mechanism. See FIG. 3B for examples.

The wireless charging apparatus can include both an array of charging coils and an array of sensing coils, which can be present in different adjacent layers, for example. By regulating the impedance of both sets of coils and selectively regulating the delivery of power to the charging coils, the operating system can, together with data provided by the sensing coils, shape the magnetic field used to transfer power selectively to different chargeable devices placed on a charging surface. Methods for performing sensing of devices, shaping of the field, and selective power distribution are described in detail in WO 2021/067692 A2.

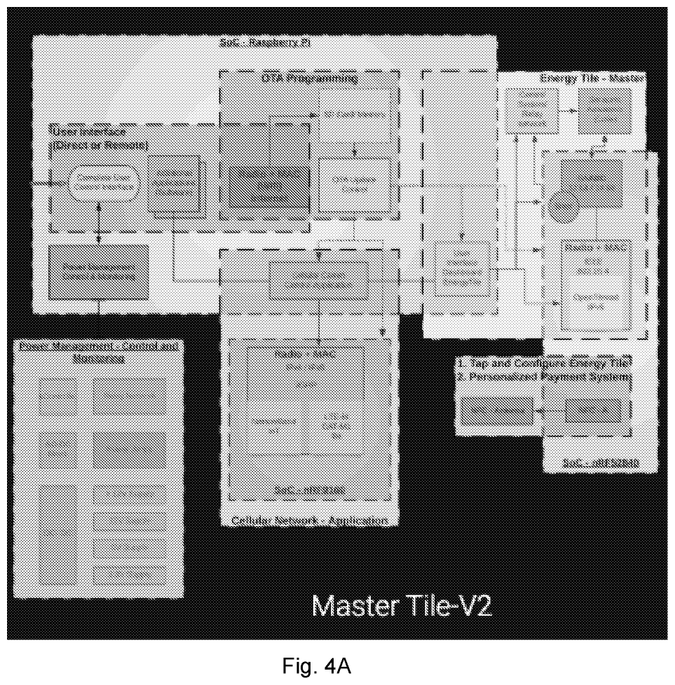

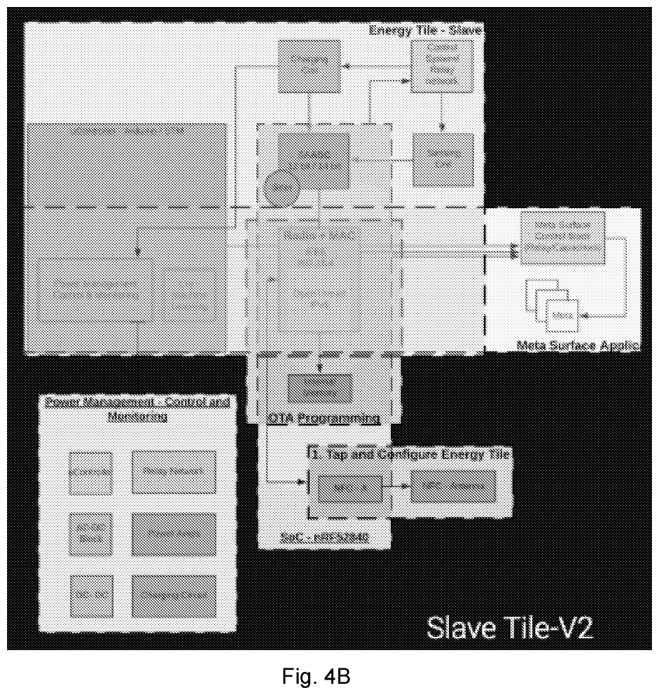

Charging coils can be encased by a housing, one or more surfaces of which serve as charging surface. Two or more sets of coils can be placed into separate housings to form tiles, which can be placed at suitable distance from one another to allow inductive coupling of the tiles to create a larger charging surface. Tiles can be placed beneath a table top, countertop, bar top, or similar horizontal flat surface that permits the magnetic field from the coils to penetrate through to the chargeable devices on the surface. In embodiments having two or more tile devices that work together, one tile can serve as the master and the others as slaves. The master provides power to its own coils, which in turn power the slave tiles by energy hoping from one tile to the next. With such an arrangement, only one unit (the master) controls the operation of the coils according to the configuration files and artificial intelligence stored in the master, and only the master needs to be provided a source of electrical power, as the slave units are powered through the master. FIGS. 4A and 4B show functional schematics of an embodiment of PCBs of a master-slave tile system.

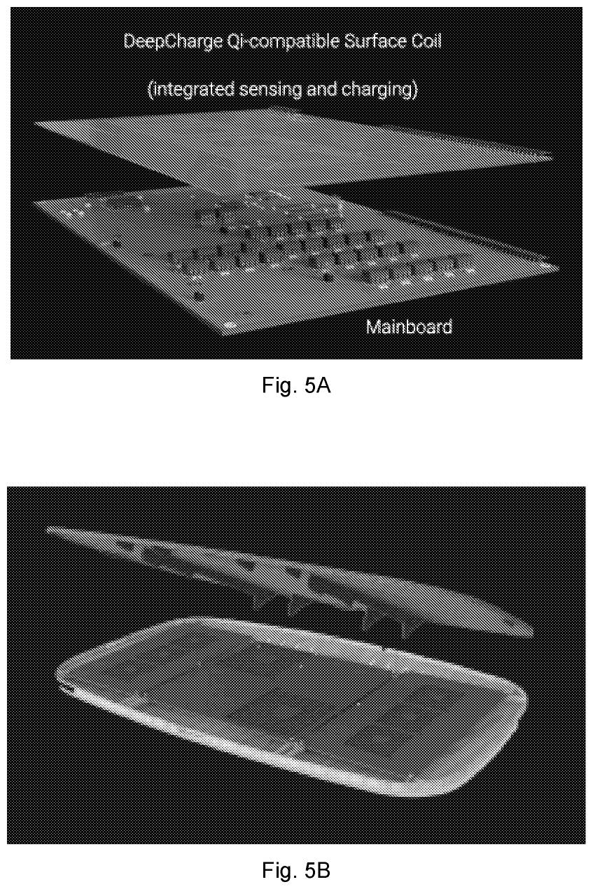

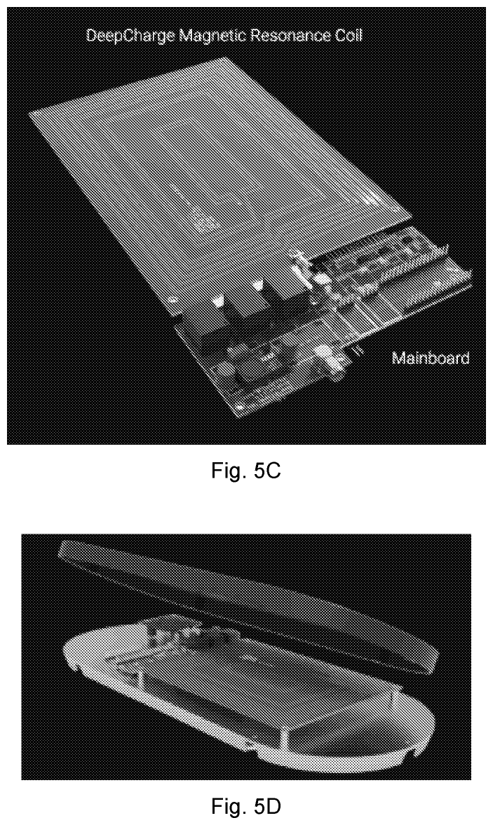

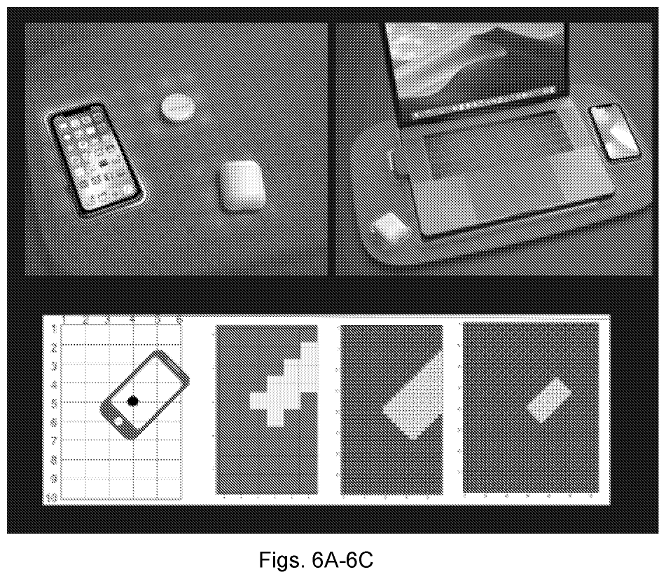

In some embodiments, the development platform includes reconfigurable wireless charging hardware kits designed to work along with the platform software and configuration files. The hardware kits can include, for example, a multi-device Qi charging pad, a laptop charging pad, and a networkable energy hub that transforms existing surfaces into contactless multi-device charging hubs. FIGS. 5A-5D show embodiments of prototype hardware for wireless charging systems, including PCBs having different coil arrangements and housings. FIGS. 6A and 6B show an embodiment of a multidevice charging surface capable of simultaneously charging several different chargeable devices, such as found at a wireless laptop workstation. FIG. 6C shows results of detecting a device at such a charging surface.

### Hardware Testing and Optimization

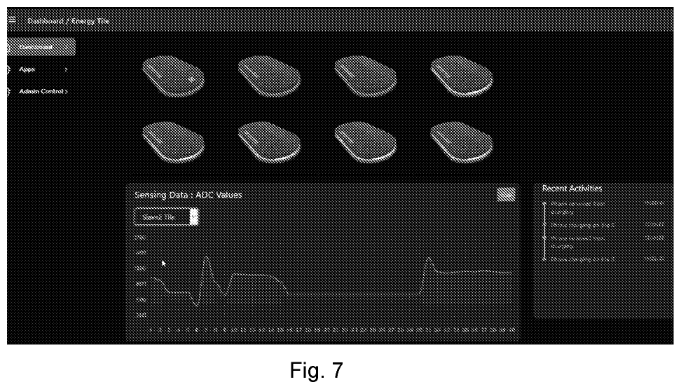

The wireless charging station development platform optionally provides for testing and refining a configuration and/or hardware design provided by the platform in real time. The platform then includes software capable of analyzing factors such as chargeable device recognition, identification, placement, and removal, power transmission, temperature during the charging process, activated coil identification, charging parameters such as power and time course, as well as identification of activated tile units and battery performance characteristics. The developer can use the information provided to alter the configuration files, hardware settings, PCB selection and the like, so as to optimize performance or ensure adherence to required standards. FIG. 7 provides an example of a “dashboard” display used to monitor a multi-tile charging system. Such displays also can be used for management of a developed wireless charging system by the end user.

The development platform described above can create wireless charging systems that outperform the technological limits previously obtainable with two specific real-world applications. The first is the creation of high-performance charging pads using artificial intelligence and optimized automated device recognition aided by artificial intelligence. For example, the present development platform can cost-effectively develop Qi-compatible charging pads that no longer require coil alignment to charge and can power multiple types of devices at the same time, including large and small electronic devices. The second is transformation of a large existing surface into a multi-device charger. An ordinary surface can be converted into a high-performing wireless power station though addition of an intelligent system of networked, hidden, energy-hopping hubs or tiles. This approach can be used to convert a table, desk, kitchen countertop, coffeeshop or restaurant table, or automobile dashboard into a wireless charging power station. In some embodiments, the platform software contains code that allows for automatous surface charging, giving the coils the ability to “sense” when any number of devices or types of devices are present on a charging surface. This enables charging devices wirelessly without the need for coil alignment.

The wireless charging system development platform described herein makes possible “charging 2.0”, a new generation of charging systems which make possible novel components and features such as reconfigurable power management, reconfigurable charging policy, intelligent thermal management, adaptive power transfer rates, collaborative-networked wireless chargers, on-demand surface sensing, optimizing battery lifetime, and flexible wireless charging area configurations. In comparison, the previous generation is characterized by fixed power management ICs, deterministic device charging policy, deterministic thermal management, fixed power transfer rates, isolated individual wireless chargers, analog ping-based sensing, tethered fixed spot charging areas, and lack of battery lifetime management.

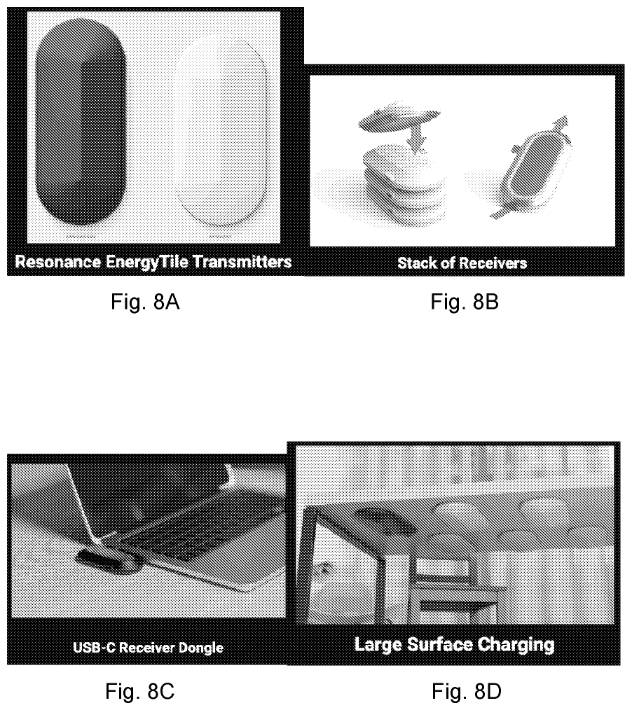

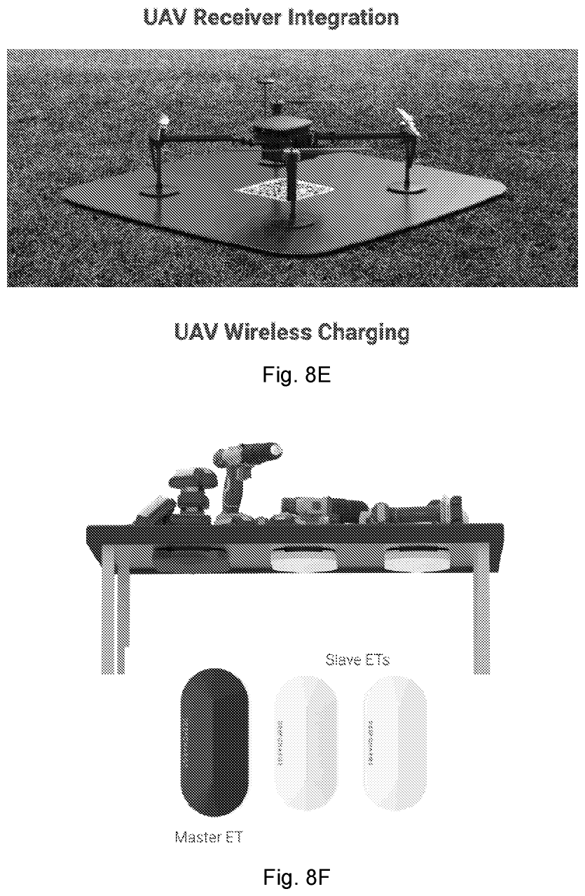

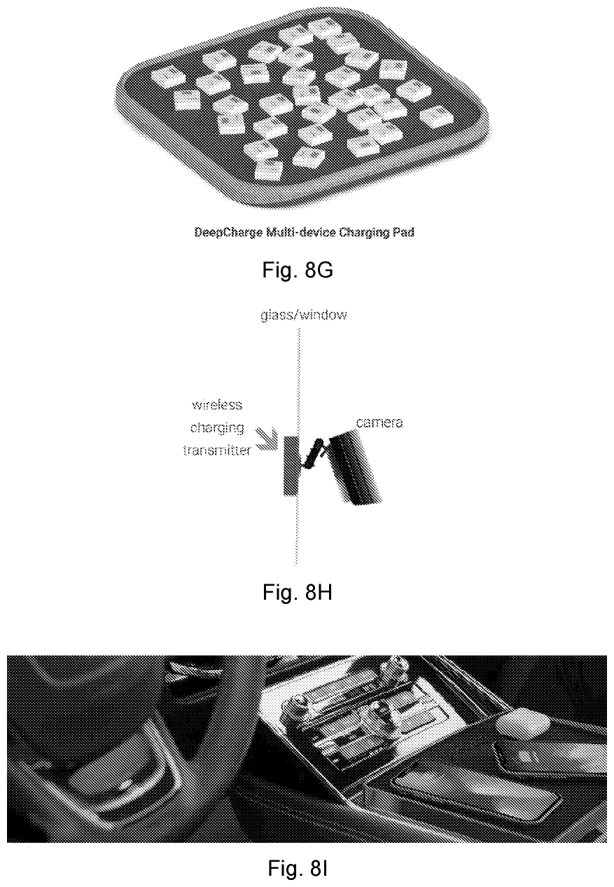

FIGS. 8A-8I depict examples of applications that can be realized with the presently described programmatic wireless charging development system. These applications include multi-device wireless charging pads, large surface wireless charging with real-time reconfigurable charging areas, wireless drone charging pads, wireless robot charging pads, and simultaneous wireless charging of multiple different power tools. Other applications not shown include wireless charging stations for electric vehicles and computer monitors. Using the present technology, wireless charging systems can be designed, constructed, and optimized for essentially any type of electronic device possessing a rechargeable battery and a receiver antenna for charging the battery. Modifications of industry charging standards can be accommodated by software updates to the customization and configuration modules, often without the need for hardware modifications. Wireless charging applications can be developed for use by consumer electronics manufacturers, furniture manufacturers, for creating shared workplaces such as office workplaces, as well as in the auto industry, the aviation industry, and the hospitality industry.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of”.

The technology described herein can be used with charging systems such as those disclosed in WO 2021/067692 A2 and US 2021/0101680 A1, the entire contents of which are incorporated by reference herein.

### REFERENCES

[1] W. P. Consortium, “Qi-mobile computing,” 2018. www.wirelesspowerconsortium.com/qi/
[2] A. Alliance, “Airfuel resonant specification,” 2014. www.airfuel.org/
[3] N. Tesla, “The transmission of electric energy without wires,” Electr. World Eng, vol. 5, pp. 162-167, 1904.
[4] D. W. Baarman, “Laptop and portable electronic device wireless power supply systems,” 2012, U.S. Pat. No. 8,164,222.
[5] S. Lukic and Z. Pantic, “Cutting the cord: Static and dynamic inductive wireless charging of electric vehicles,” IEEE Electrification Magazine, vol. 1, no. 1, pp. 57-64, 2013, 2013.
[6] A. Mashinsky, “Self-charging electric vehicles and aircraft, and wireless energy distribution system,” 2015, U.S. Pat. No. 8,890,472.
[7] U. K. Madawala and D. J. Thrimawithana, “A bidirectional inductive power interface for electric vehicles in v2g systems,” IEEE Trans on Indus Elec, vol. 58, no. 10, pp. 4789-4796, 2011.
[8] O. C. Onar, J. M. Miller, S. L. Campbell, C. Coomer, C. P. White, and L. E. Seiber, “A novel wireless power transfer for in-motion ev/phev charging,” pp. 3073-3080, 2013.
[9] B. Sun and D. H. Tsang, “Performance analysis of dynamic wireless charging system for electric vehicles: A queueing approach,” in Proceedings of the Eighth International Conference on Future Energy Systems, 2017, pp. 168-178.
[10] S. Aldhaher, P. D. Mitcheson, J. M. Arteaga, G. Kkelis, and D. C. Yates, “Light-weight wireless power transfer for mid-air charging of drones,” in 2017 11th European Conference on Antennas and Propagation (EUCAP), 2017, pp. 336-340.
[11] C. H. Choi, S. G. Jang, H J and Lim, H. C. L, S. H. Cho, and Gaponov, “Automatic wireless drone charging station creating essential environment for continuous drone operation,” in IEEE ICCAIS, 2016, pp. 132-136.
[12] Y. L. Li, Y. Wang, Y. Cheng, X. Li, and G. L. Xing, “Qiloc: A qi wireless charging based system for robust user-initiated indoor location services,” pp. 480-488, 2015.
[13] J. Jadidian and D. Katabi, “Magnetic mimo: How to charge your phone in your pocket,” in ACM MobiCom, 2014, pp. 495-506.
[14] A. Kurs, A. Karalis, R. Moffatt, J. D. Joannopoulos, and P. Fisher, “Wireless power transfer via strongly coupled magnetic resonances,” Science, vol. 317, no. 5834, pp. 83-86, 2007.
[15] L. X. Shi, Z. Kabelac, D. Katabi, and D. Perreault, “Wireless power hotspot that charges all of your devices,” in ACM MobiCom, 2015, pp. 2-13.
[16] W. Zhong, C. K. Lee, and S. Y. R. Hui, “General analysis on the use of tesla's resonators in domino forms for wireless power transfer,” IEEE Tran on Indus Elec, vol. 60, no. 1, pp. 261-270, 2012.
[17] C. K. Lee, W. X. Zhong, and S. Y. R. Hui, “Effects of magnetic coupling of nonadjacent resonators on wireless power domino-resonator systems,” IEEE Tran on Power Elec, vol. 27, no. 4, pp. 1905-1916, 2012.
[18] C. J. Stevens, “Magnetoinductive waves and wireless power transfer,” IEEE Tran on Power Elec, vol. 30, no. 11, pp. 6182-6190, 2015.
[19] B. Wang, W. Yerazunis, and K. H. Teo, “Wireless power transfer: Metamaterials and array of coupled resonators,” Proceedings of the IEEE, vol. 101, no. 6, pp. 1359-1368, 2013.
[20] X. Shi and J. R. Smith, “Large area wireless power via a planar array of coupled resonators,” in 2016 International Workshop on Antenna Technology (iWAT), 2016, pp. 200-203.
[21] B. H. Waters, P. R. Fidelman, J. D. Raines, and S. R. Joshua, “Simultaneously tuning and powering multiple wirelessly powered devices,” in 2015 IEEE Wireless Power Transfer Conference (WPTC). IEEE, 2015, pp. 1-4.
[22] J. Xiong and K. Jamieson, “Arraytrack: A fine-grained indoor location system,” in Symposium on Networked Systems Design and Implementation ({NSDI} 13), 2013, pp. 71-84.
[23] D. Bharadia, K. R. Joshi, M. Kotaru, and S. Katti, “Backfi: High throughput wifi backscatter,” vol. 45, no. 4, 2015, pp. 283-296.
[24] U. Ha, Y. F. Ma, T.-M. Zhong, Z X and Hsu, and F. Adib, “Learning food quality and safety from wireless stickers.” in HotNets, 2018, pp. 106-112.
[25] C. Stevens, E. Shamonina, J. Paszkiewicz, “Magnetoinductive waveguide”, U.S. Pat. No. 10,931,252/.
[26] S.-Y. Wang, P. Kuekes, W. Wu, J. Straznicky, M. Islam, “Composite material with powered resonant cells”, U.S. Pat. No. 7,205,941.
[27] K. Sayyah, J. H. Schaffner, P. R. Patterson, “Tunable optical metamaterial”, U.S. Pat. No. 8,908,251.

What is claimed is:

1. A system for programmatically designing a software-defined wireless charging apparatus, the system comprising a processor configured to:
(i) receive an input of specifications from a user for the wireless charging apparatus using developer software;
(ii) generate one or more configuration files for the wireless charging apparatus based on the specifications using the developer software; and
(iii) configure operating software for the wireless charging apparatus using the developer software in accordance with the configuration files;
wherein the wireless charging apparatus is designed for simultaneously charging one or more chargeable devices.

2. The system of claim 1, wherein the specifications are input by the user through a configuration menu of the developer software.

3. The system of claim 1 or claim 2, wherein the specifications are selected from the group consisting of types of device to be charged, number of devices to be charged simultaneously, charging area size, output power requirements, charging standard to be used, hardware configuration of the wireless charging apparatus and combinations thereof.

4. The system of any of the preceding claims, wherein the operating software is configured in (iii) with respect to its ability to sense the presence, size, position, and/or identity of chargeable devices disposed on a charging surface of the wireless charging apparatus; shape an energy field over the charging surface based on size, position, and/or identity of detected devices on the charging surface; allocate power to a plurality of devices and/or of different types of devices on the charging surface; activate and set operational characteristics of one or more charging coils disposed beneath the charging surface; execute one or more charging policies for devices on the charging surface; share information among energy hubs of the system; and/or collect and share information related to charging of chargeable devices on the charging surface.

5. The system of any of the preceding claims, further comprising:
(iv) generating a configurable hardware design and/or listing of hardware components for the wireless charging apparatus using the one or more configuration files and the developer software.

6. The system of claim 5, wherein the configurable hardware design comprises a layout of configurable charging coils disposed on one or more printed circuit boards.

7. The system of claim 5 or claim 6, wherein the configurable hardware design comprises a configurable power supply disposed on a printed circuit board.

8. The system of any of claims 5-7, wherein the configurable hardware design comprises a configurable charging coil array.

9. The system of any of claims 5-8, wherein the configurable hardware design comprises a firmware stack.

10. The system of any of claims 5-9, wherein the configurable hardware design comprises a plurality of charging hubs for attachment to a lower side of a surface to create a charging surface, wherein the plurality of charging hubs are configured to transmit energy amongst one another by induction, and wherein each of the plurality of charging hubs is configured to transmit energy through the surface to charge one or more devices disposed on an upper side of the surface.

11. The system of claim 10, wherein the plurality of charging hubs comprises a master hub and one or more slave hubs, and wherein the master hub is connected to a power source and transmits energy to the one or more slave hubs.

12. The system of claim 10 or claim 11, wherein the surface is selected from the group consisting of furniture surfaces, tables, desks, restaurant and coffeeshop tables, countertops, bar tops, and surfaces of motor vehicles, planes, and trains.

13. The system of any of the preceding claims, further comprising one or more pre-defined configurable hardware designs available for selection by the developer software in accordance with the configuration files.

14. The system of any of the preceding claims, wherein the one or more chargeable devices include at least two different types of chargeable devices.

15. The system of any of the preceding claims, wherein the one or more chargeable devices are selected from the group consisting of smartphones, smartwatches, wireless headphones, laptops, computer displays, touchpads, pointing devices, wireless speakers, smart home devices, remote controls, cameras, televisions, radios, medical devices, power tools, drones, robots, and electric vehicles.

16. The system of any of the preceding claims, wherein the operating software is configured with respect to its ability to receive and/or display performance data from the wireless charging apparatus.

17. The system of claim 16, wherein the performance data comprise power transmission data, power receipt data from a chargeable device, charging efficiency, projected battery life, and/or temperature data.

18. A software-defined wireless charging apparatus designed by the system of any of the preceding claims, wherein the wireless charging apparatus comprises:
an array of charging coils;
an array of sensing coils;
a power module; and
a processor configured to sense and identify one or more chargeable devices placed in proximity to the charging coils and operate the charging coils and power module so as to charge said one or more chargeable devices;
wherein the wireless charging apparatus is operational to simultaneously charge one or more chargeable devices.

19. The software-defined wireless charging apparatus of claim 18, wherein the apparatus is operational to simultaneously charge different types and/or numbers of chargeable devices and/or to charge devices having different power requirements.

20. The software-defined wireless charging apparatus of claim 18 or claim 19, further comprising one or more of an internet node, a 4G network node, a 5G network node, and an edge computing network node.

21. The software-defined wireless charging apparatus of any of claims 18-20, wherein the apparatus is configured as a plurality of charging hubs for attachment to a lower side of a surface to create a charging surface, wherein the plurality of charging hubs are configured to transmit energy amongst one another by induction, and wherein each of the plurality of charging hubs is configured to transmit energy through the surface to charge one or more devices disposed on an upper side of the surface.

22. The software-defined wireless charging apparatus of any of claims 18-21, wherein the one or more chargeable devices are selected from the group consisting of smartphones, smartwatches, wireless headphones, laptops, computer displays, touchpads, pointing devices, wireless speakers, smart home devices, remote controls, cameras, televisions, radios, medical devices, power tools, drones, robots, and electric vehicles.

23. The software-defined wireless charging apparatus of any of claims 18-22, wherein the device is configured as a laptop work surface, a laptop case, a computer monitor, tablet, or television stand, a desk top, a counter top, a table top, an article of furniture, an airplane drop-down table, a robot charging device, an unmanned aerial vehicle charging device, an automotive vehicle charging device, a power tool charging device, or a multipurpose device charging surface.

24. The software-defined wireless charging apparatus of any of claims 18-23, wherein the processor is further configured to collect data related to device charging characteristics, battery status, power usage by device, coil configuration, or temperature of the apparatus, and optionally transmit the data to a mobile phone app.

25. A method of designing a software-defined wireless charging apparatus comprising the steps of:
(a) inputting specifications of the wireless charging apparatus into wireless charging apparatus developer software;
(b) generating one or more configuration files for the wireless charging apparatus based on the specifications using the developer software; and
(c) configuring operating software for the wireless charging apparatus using the developer software based on the one or more configuration files;
wherein the wireless charging apparatus is designed for simultaneously charging one or more chargeable devices.

26. The method of claim 25, further comprising:
(d) generating a configurable hardware design and/or listing of hardware components for the wireless charging apparatus using the one or more configuration files and the developer software.

27. The method of claim 25, wherein the configurable hardware design comprises a layout of configurable charging coils disposed on one or more printed circuit boards.

28. The method of claim 26 or claim 27, wherein the configurable hardware design comprises a configurable power supply disposed on a printed circuit board.

29. The method of any of claims 26-28, wherein the configurable hardware design comprises a configurable charging coil array.

30. The method of any of claims 26-29, wherein the configurable hardware design comprises a firmware stack.

31. The method of any of claims 25-30, wherein the specifications are input by the user through a configuration menu.

32. The method of any of claims 25-31, wherein the specifications are selected from the group consisting of types of device to be charged, number of devices to be charged simultaneously, charging area size, output power requirements, charging standard to be used, hardware configuration of the wireless charging apparatus, and combinations thereof.

33. The method of any of claims 25-32, wherein the operating software is configured in (c) with respect to its ability to sense the presence, size, position, and/or identity of chargeable devices disposed on a charging surface of the wireless charging apparatus; shape an energy field over the charging surface based on size, position, and/or identity of detected devices on the charging surface; allocate power to a plurality of devices and/or of different types of devices on the charging surface; activate and set operational characteristics of one or more charging coils disposed beneath the charging surface; execute one or more charging policies for devices on the charging surface; share information among energy hubs of the system; and/or collect and share information related to charging of chargeable devices on the charging surface.

34. The method of any of claims 25-33, wherein the configurable hardware design comprises a plurality of charging hubs for attachment to a lower side of a surface to create a charging surface, wherein the plurality of charging hubs are configured to transmit energy amongst one another by induction, and wherein each of the plurality of charging hubs is configured to transmit energy through the surface to charge one or more devices disposed on an upper side of the surface.

35. The method of claim 34, wherein the plurality of charging hubs comprises a master hub and one or more slave hubs, and wherein the master hub is connected to a power source and transmits energy to the one or more slave hubs.

36. The method of claim 34 or claim 35, wherein the surface is selected from the group consisting of furniture surfaces, tables, desks, restaurant and coffeeshop tables, countertops, bar tops, and surfaces of motor vehicles, planes, and trains.

37. The method of any of claims 26-36, wherein the configurable hardware design configured by the developer software is selected from one or more pre-defined configurable hardware designs available for selection by the developer software in accordance with the configuration files.

38. The method of any of claims 25-37, wherein the one or more chargeable devices include at least two different types of chargeable devices.

39. The method of any of claims 25-38, wherein the one or more chargeable devices are selected from the group consisting of smartphones, smartwatches, wireless headphones, laptops, computer displays, touchpads, pointing devices, wireless speakers, smart home devices, remote controls, cameras, televisions, radios, medical devices, power tools, drones, robots, and electric vehicles.

40. The method of any of claims 25-39, wherein the operating system is operative to collect performance data from the wireless charging apparatus and displaying the performance data and/or representations thereof for evaluation by a user.

41. The method of claim 40, further comprising:
(e) collecting said performance data;
(f) using the developer software to generate one or more revised configuration files for the wireless charging apparatus; and
(g) reconfiguring the operating software using the developer software in accordance with the revised configuration files.

42. The method of claim 41, wherein steps (e) through (g) are repeated one or more times.

43. The method of any of claims 40-42, wherein the performance data comprise power transmission data, power receipt data from a chargeable device, charging efficiency, projected battery life, and/or temperature data.

44. A system for wireless charging, the system comprising:
(i) the software-defined wireless charging apparatus of any of claims 18-24; and
(ii) a power receiver for receiving energy from the wireless charging apparatus.

45. The system of claim 44, wherein the power receiver is integrated within a chargeable device.

46. The system of claim 45, wherein the power receiver is integrated within a batter of the chargeable device.

47. The system of claim 44, wherein the power receiver is disposed in a separate device.

48. The system of claim 47, wherein the separate device is selected from a power dongle that attaches to a chargeable device, a case for a chargeable device, and a stand for a chargeable device.

49. The system of any of claims 44-48, wherein the power receiver is operative to send feedback data to the wireless charging apparatus.
